(19) United States
(12) Patent Application Publication
(10) Pub. No.: US 2026/0246543 A1
(43) Pub. Date: Aug. 20, 2026

(54) ERROR ESTIMATION

(71) Applicant: VIAVI Solutions Inc., Chandler, AZ (US)

(72) Inventors: Sohail PAYAMI, Essex (GB); Adrian JONES, Letchworth (GB); Chi-ming LEUNG, Hardwick (GB); Stephen WANG, London (GB)

(21) Appl. No.: 19/324,281

(22) Filed: Sep. 10, 2025

Related U.S. Application Data
(63) Continuation-in-part of application No. 19/057,286, filed on Feb. 19, 2025.

(51) Int. Cl. H04B 17/17; H04B 17/309

(52) U.S. Cl. CPC H04B 17/17; H04B 17/309

(57) ABSTRACT

In some implementations, a test system may receive first and second signals. The first and second signals may be transmitted by a base station and may be symmetric on a horizontal domain without any beam tilt in a vertical domain. The first signal may be associated with a first antenna port and the second signal may be associated with a second antenna port. The test system may extract first data from the first signal and second data from the second signal. The first data and the second data may be associated with one or more wireless communication channels. The test system may normalize, based on the first data, the second data. The test system may estimate a residual error associated with the second antenna port based on the normalized second data. The test system may assess a performance of the base station based on the residual error.

### CROSS-REFERENCE TO RELATED APPLICATION

This patent application claims priority to U.S. patent application Ser. No. 19/057,286, filed on Feb. 19, 2025, and entitled “ERROR ESTIMATION WITH INLINE SPATIAL CHANNEL MODEL.” The disclosure of the prior application is considered part of and is incorporated by reference into this patent application.

### BACKGROUND

A spatial channel model (SCM) is a model that can be used to evaluate or represent multiple-antenna systems, algorithms, and multiple-input multiple-output (MIMO) communication links. A test system may be configured to perform cable-connected testing of a MIMO base station via an analog or digital SCM. For example, an SCM may be configured to predict a behavior of a wireless communication signal within a wireless communication network, including the angles at which the wireless communication signal arrives at a device receiving the wireless communication signal and departs from a device transmitting the wireless communication signal.

### SUMMARY

Some implementations described herein relate to a method. The method may include receiving, by a test system, a first signal and a second signal, wherein the first signal and the second signal are transmitted by a base station, wherein the first signal and the second signal are symmetric on a horizontal domain without any beam tilt in a vertical domain, and wherein the first signal is associated with a first antenna port and the second signal is associated with a second antenna port. The method may include extracting, by the test system, first data from the first signal and second data from the second signal, wherein the first data and the second data are associated with one or more wireless communication channels. The method may include normalizing, by the test system and based on the first data, the second data to generate normalized second data. The method may include estimating, by the test system, a residual error associated with the second antenna port based on the normalized second data. The method may include assessing, by the test system, a performance of the base station based on the residual error.

Some implementations described herein relate to a method. The method may include receiving, by a test system, a plurality of repetitions of a first signal and a second signal, wherein the plurality of repetitions of the first signal and the second signal are transmitted by a base station using beam weights that are progressively increasing in a horizontal domain and a vertical domain, and wherein the first signal is associated with a first antenna port and the second signal is associated with a second antenna port. The method may include for each repetition of the plurality of repetitions of the first signal and the second signal, extracting, by the test system, first data from the first signal and second data from the second signal, wherein the first data and the second data are associated with one or more wireless communication channels determining, by the test system and based on the first data and the second data, relative progressive phase differences between the first antenna port and the second antenna port on the horizontal domain and on the vertical domain determining, by the test system and based on the relative phase differences, a first beamforming weight associated with the first signal and a second beamforming weight associated with the second signal. The method may include estimating, by the test system, a residual error associated with the second antenna port based on the first data, the second data, the first beamforming weight, and the second beamforming weight. The method may include assessing, by the test system, a performance of the base station based on the residual error.

Some implementations described herein relate to a test system. The test system may include one or more memories and one or more processors coupled to the one or more memories. The one or more processors may be configured to receive a first signal and a second signal, wherein the first signal and the second signal are transmitted by a base station, wherein the first signal and the second signal are symmetric on a horizontal domain without any beam tilt in a vertical domain, and wherein the first signal is associated with a first antenna port and the second signal is associated with a second antenna port. The one or more processors may be configured to extract first data from the first signal and second data from the second signal, wherein the first data and the second data are associated with one or more wireless communication channels. The one or more processors may be configured to normalize, based on the first data, the second data to generate normalized second data. The one or more processors may be configured to estimate a residual error associated with the second antenna port based on the normalized second data. The one or more processors may be configured to assess a performance of the base station based on the residual error.

### BRIEF DESCRIPTION OF THE DRAWINGS

FIGS. 1A-1J are diagrams of an example implementation associated with error estimation with an inline spatial channel model.

FIG. 2 is a diagram of an example environment in which systems and/or methods described herein may be implemented.

FIG. 3 is a diagram of example components of a device associated with error estimation with an inline SCM.

FIG. 4 is a flowchart of an example process associated with error estimation with an inline spatial channel model.

FIG. 5 is a flowchart of an example process associated with error estimation with an inline spatial channel model.

### DETAILED DESCRIPTION

The following detailed description of example implementations refers to the accompanying drawings. The same reference numbers in different drawings may identify the same or similar elements.

In some cases, a spatial channel model (SCM) may be used for assessing a performance of a base station. The SCM may be a matrix (e.g., a phase shift matrix (PSM) or a Butler matrix) that is configured to emulate the spatial aspects of a wireless communication channel.

In some cases, the SCM is configured to map A antenna ports to B beam ports. The A antenna ports may be connections via which signals are communicated between the base station and the SCM. The B beam ports may be connections via which signals are communicated between the SCM and other devices or components associated with the SCM. In some cases, one or more of the B beam ports may be used to provide an emulated far field signal to an emulated user equipment (UE) and/or to receive signals from the emulated UE. In some cases, the emulated UE may be configured as a two or four layer multiple-input multiple-output (MIMO) UE. In some cases, when configured as a four layer MIMO UE, the emulated UE may require two dual-polarized beams, which may be set to the same angles.

In some cases, the base station may be a multi-user MIMO (MU-MIMO) base station that is configured to perform spatial multiplexing for communicating multiple simultaneous beams with one or more UEs. To assess a performance of the base station, the SCM may be configured to receive signals transmitted via an N×M antenna array of the base station, where N and M are the total number of antennas on the horizontal and vertical dimensions, respectively, per polarization. For example, a set of wired connections may be used to connect the antenna ports of the SCM to the antenna array of the base station via one or more fixed attenuators.

In some cases, the SCM may receive a signal transmitted by the base station via the set of wired connections. The received signal (AF) at a particular location may be given by:

$$A F ( {ψ}_{H} , {ψ}_{V} ) = {\sum }_{m = 0}^{M - 1} {\sum }_{n = 0}^{N - 1} {a}_{nm} {e}^{jn {ψ}_{H}} {e}^{jm {ψ}_{V}} ,$$

where

$${ψ}_{H} = β {d}_{H} sin ∅cos {θ}_{v} , {ψ}_{V} = β {d}_{V} sin {θ}_{v} , β = \frac{2 π}{λ} ,$$

where λ is a wavelength of the signal, and an, is the signal of the nth horizontal (H) antenna element and the mth vertical (V) antenna element.

In some cases, the element spacings (d) of the antenna elements of the antenna array may be different in the vertical direction (V) and the horizontal direction (H), and the signal (AF) may vary in azimuth (Φ) and elevation (Θᵥ). In some cases, to emulate a scenario in which the element spacings d of the antenna elements of the antenna array are different in the vertical direction V and the horizontal direction H, and the signal AF varies in azimuth Φ and elevation Θᵥ at a particular location, the SCM may sum signals at the antenna ports with a weighting of e^{jnψ}^{_{H}}e^{jmψ}^{_{V}}.

In some cases, the weighting may be phase ramps across the vertical and horizontal directions of the antenna array. The rate at which the phase ramps may depend on the azimuth P and elevation Θᵥ at the particular location.

In some cases, the base station may transmit multiple beams simultaneously to enable spatial multiplexing. The beams may have a finite width and side lobes. To reduce interference between the beams, the base station may select a set of orthogonal beams. Therefore, to determine a maximum capacity for the base station, the SCM may be configured with a set of orthogonal beams.

In some cases, the SCM may be a Butler matrix, which is designed to provide a set of orthogonal beams. In other cases, the SCM may not be a Butler matrix. In these cases, the SCM may be configured with a set of orthogonal angles for a uniform linear array (ULA). In some cases, assuming that the base station is using uniform excitation, the set of orthogonal angles may be determined using the following equation:

$$ψ i = 2 π ( \frac{i + x}{{N}_{e l e}} ) ,$$

where

$$i = - \frac{{N}_{e l e}}{2} … \frac{{N}_{e l e}}{2} - 1 ,$$

and x is an arbitrary rotation factor ranging from 0 to 1. For two dimensions, the above equation can be used in both the horizontal and vertical directions, applying the appropriate antenna element (Nₑₗₑ), and then translating to (Φ, Θᵥ) if required.

In some cases, one or more sources of uncertainty may affect beam isolation. For example, beam isolation may be affected by base station uncertainty (e.g., residual uncompensated offsets), errors due to a length mismatch between cables used to connect the SCM to the base station, and/or errors due to an accuracy of the SCM, among other examples.

In some cases, the SCM may be calibrated to compensate for one or more sources of uncertainty. However, the remaining sources of uncertainties (“residual error”) may remain. In some cases, the residual error may be associated with each antenna port of the SCM. In some cases, the residual error may be constant in time but random with respect to the individual antenna ports.

In some cases, the residual error may result in residual beam isolations of 25-35 decibels (dB). In some cases, the resulting residual beam isolations are insufficient for determining a maximum multi-beam capacity of the base station.

Some implementations described herein enable a test system to estimate, and compensate for, residual errors. In some aspects, the test system may determine a residual error associated with each antenna port. In some aspects, an emulated UE connects to two or more beam ports of an SCM of the test system and extracts data relating to one or more communication channels. In some aspects, the data relating to the one or more communication channels may be extracted simultaneously with data relating to a reference channel. In some aspects, the data relating to the reference channel may be used as a phase reference and the residual error associated with each antenna port may be determined relative to the phase reference and, optionally, based on beam weights used by the base station.

As a result, the estimated residual error determined for each antenna port can be used to identify and/or correct errors associated with the base station, the components used to establish a connection between the base station and the test system, and the SCM. In some aspects, the estimated residual error determined for each antenna port can be used as additional calibration coefficients for calibrating an SCM of the test system, thereby improving a performance of the SCM. Additionally, the estimated residual errors may be used to diagnose connection issues and/or calibration issues associated with the base station and/or the test system.

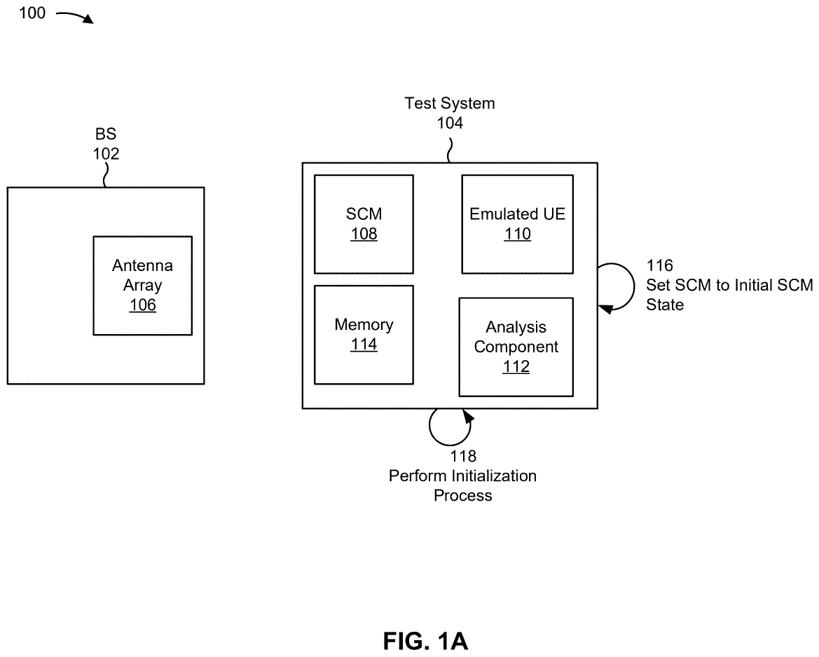

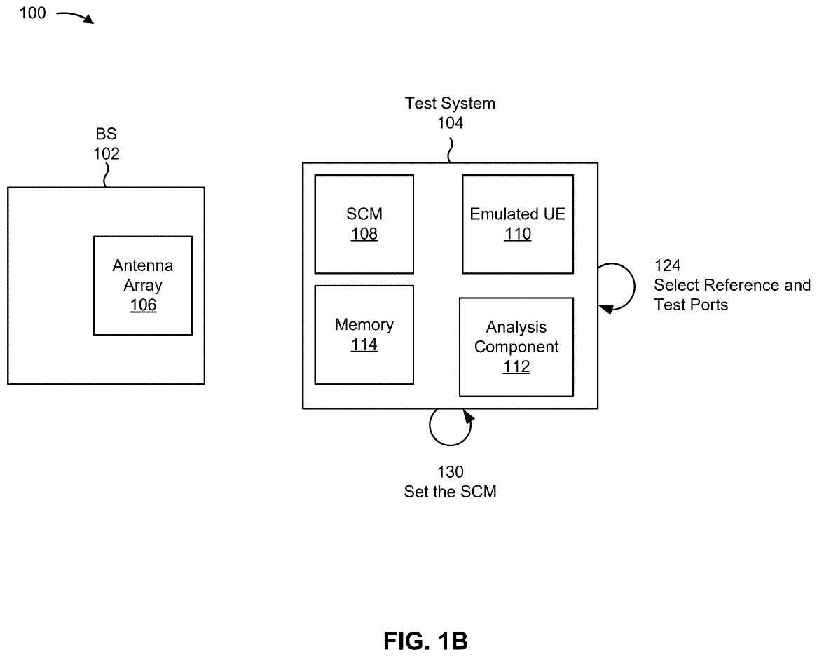

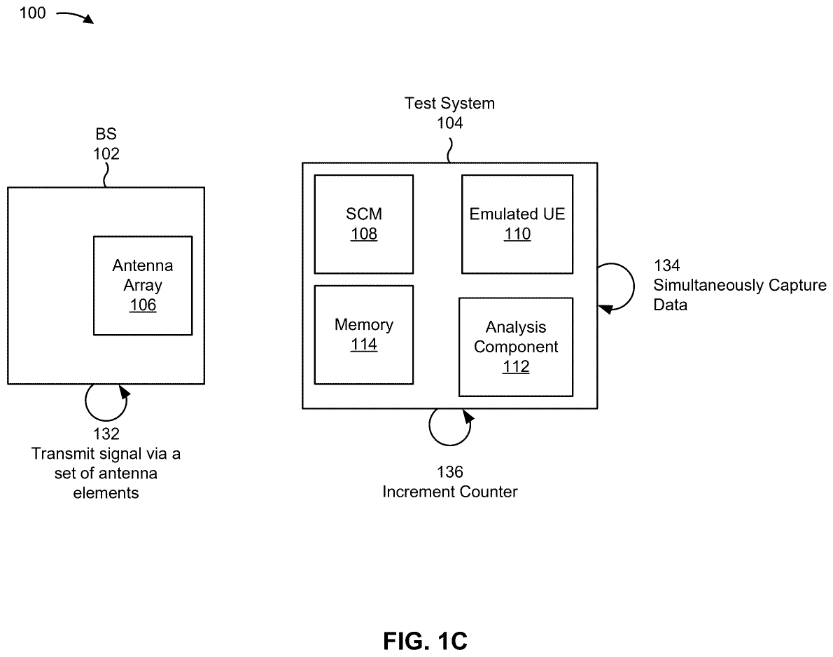

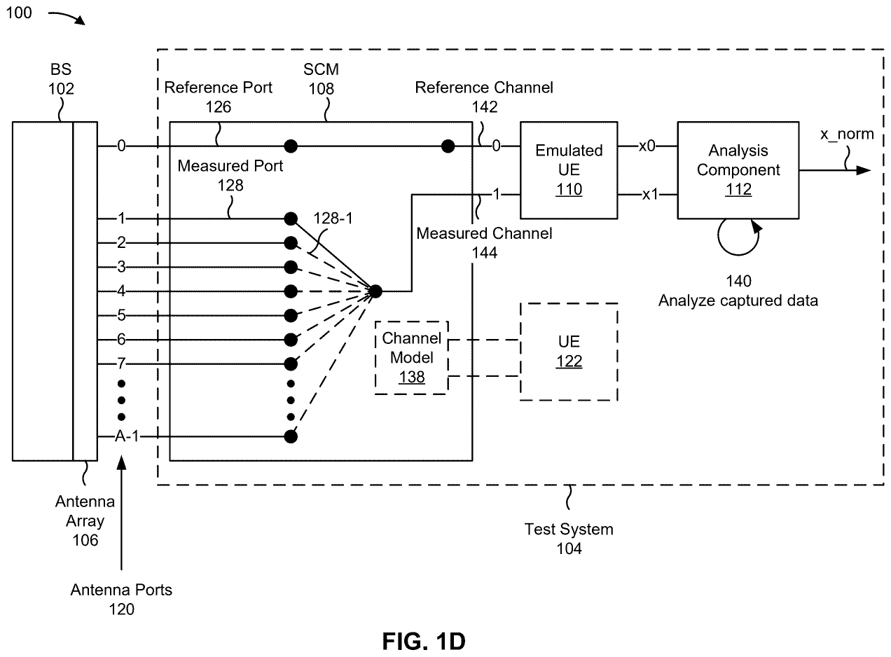

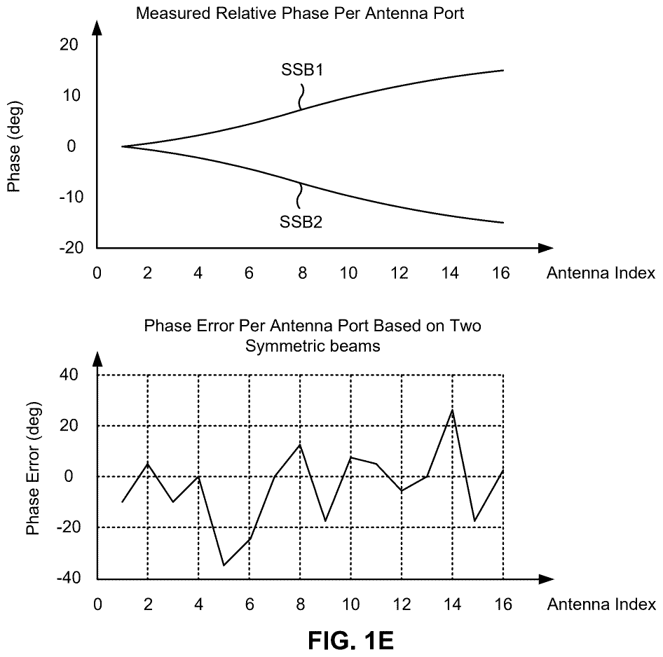

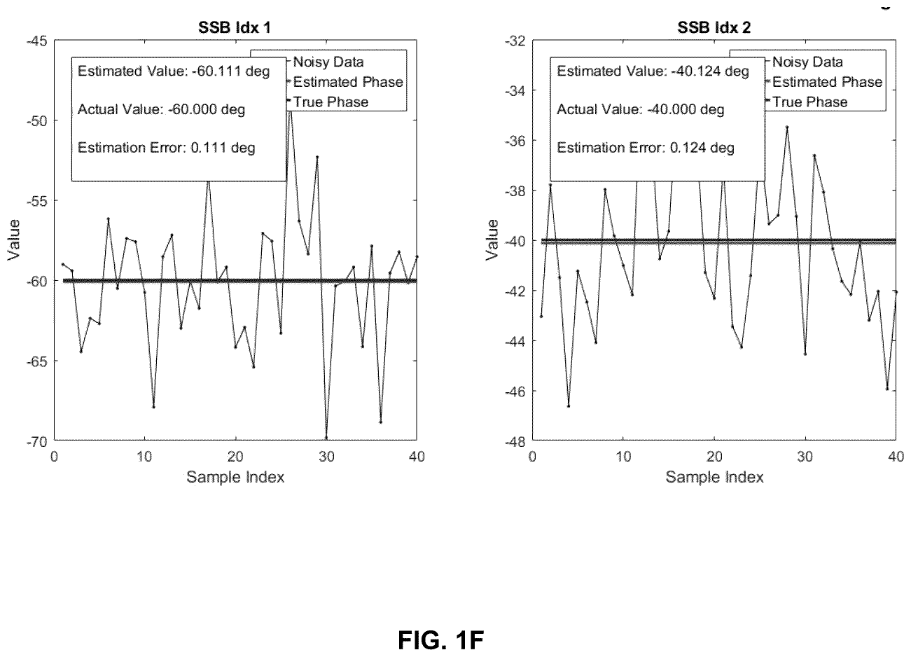

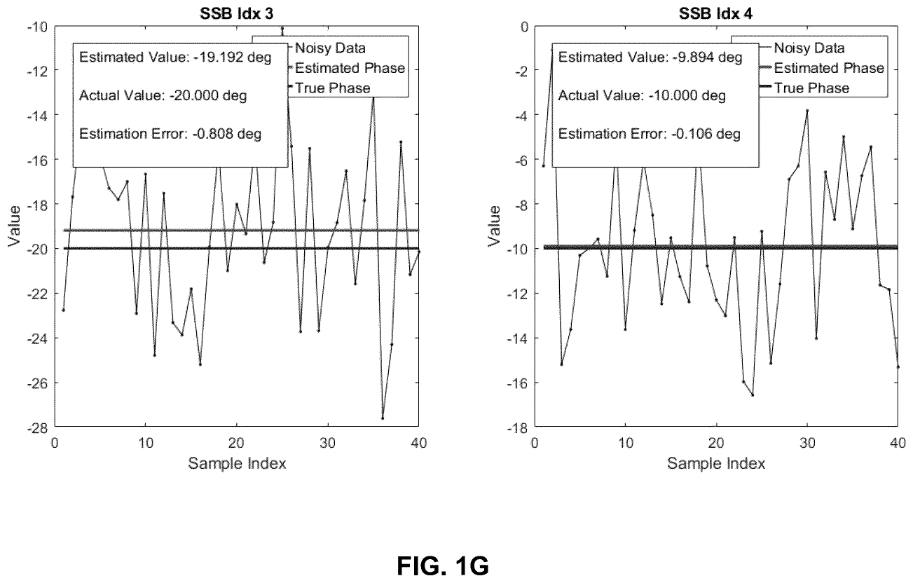

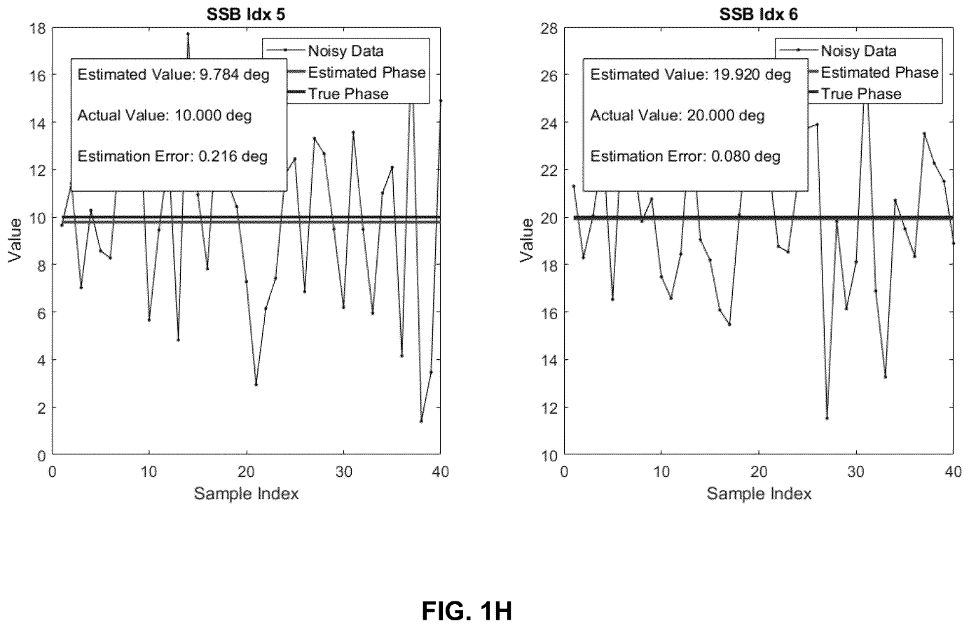

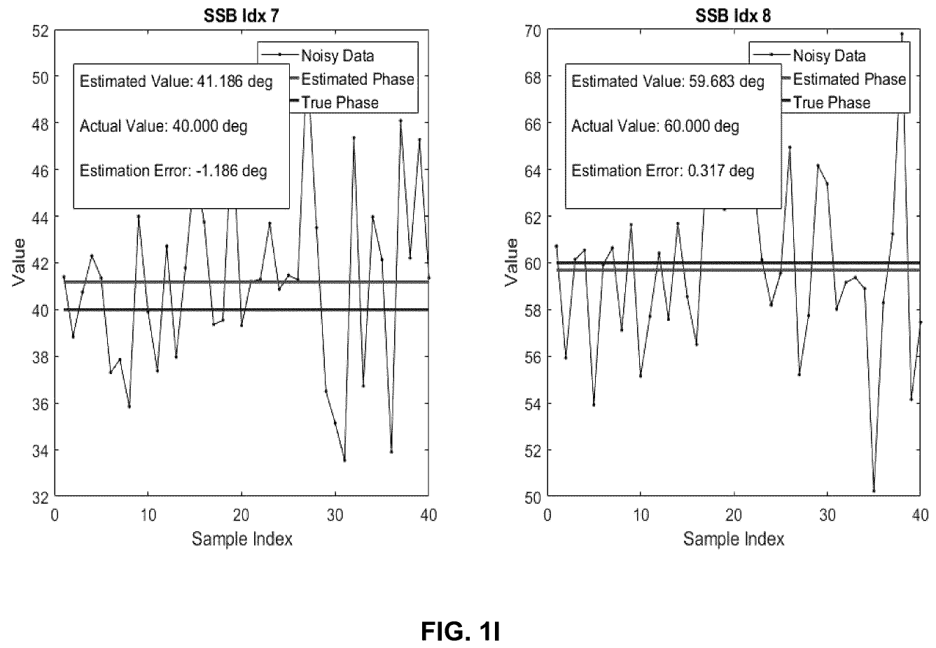

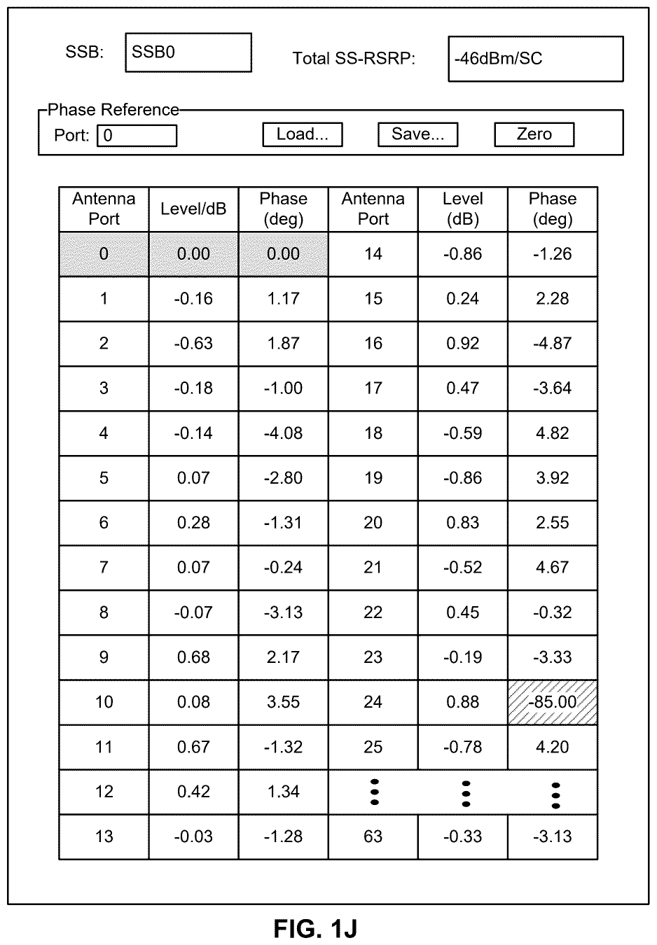

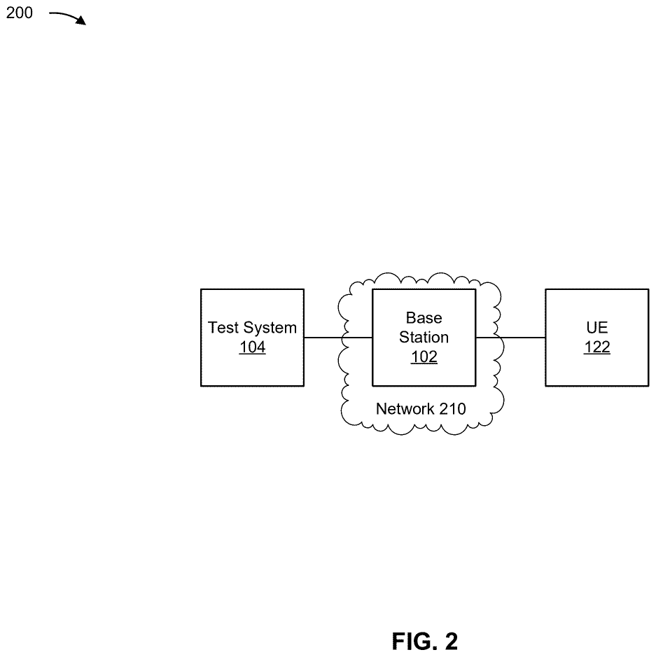

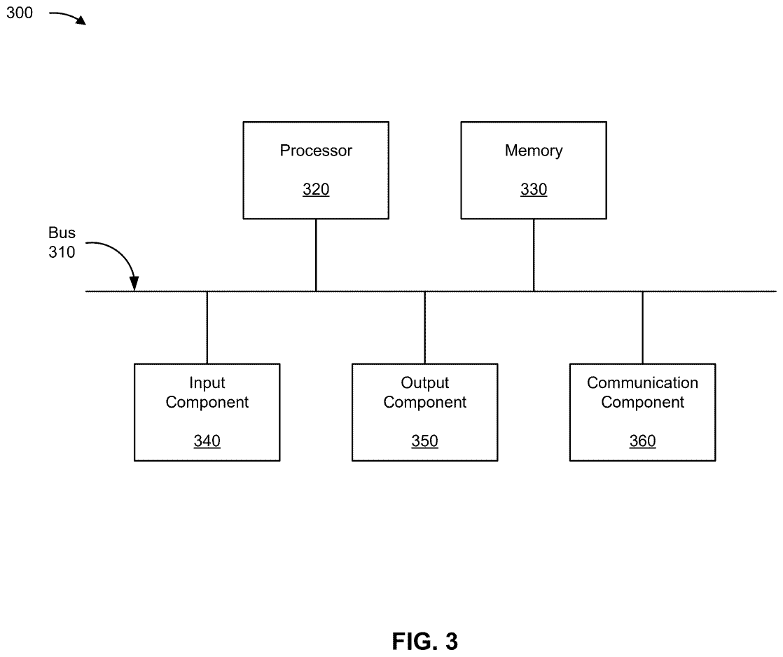

FIGS. 1A-1J are diagrams of an example implementation 100 associated with error estimation with an inline spatial channel model. As shown in FIGS. 1A-1J, example implementation 100 includes a base station 102 and a test system 104. As shown in FIG. 1A, the base station 102 may include an antenna array 106 that includes a quantity (A) of antennas (not shown). As also shown in FIG. 1A, the test system 104 may include an SCM 108, an emulated UE 110, an analysis component 112, and a memory 114. These devices are described in more detail below and in connection with FIG. 2 and FIG. 3.

In some aspects, the SCM 108 may be configured to emulate spatial aspects of a communication channel. For example, the SCM 108 may include an arbitrary PSM that can be configured to emulate different locations of a UE. As another example, the SCM 108 may include a Butler matrix that is configured to emulate fixed locations of a UE.

In some aspects, the SCM 108 may include a set of antenna ports and a set of beam ports. In some aspects, the antenna ports may be a set of connections for communicating signals between the SCM 108 and the base station 102. For example, the antenna ports may be configured to receive signals transmitted by the base station 102 and/or to transmit signals to the base station 102.

In some aspects, the beam ports may be a set of connections for communicating signals between the SCM 108 and one or more components of the test system 104. For example, the beam ports may be configured to output an emulated signal generated by the SCM 108 and/or to receive a signal from a component (e.g., an emulated UE component) of the test system 104.

As shown by reference number 116, the test system 104 may set the SCM 108 to an initial SCM state. In some aspects, the SCM 108 may be configured with a set of parameters and the test system 104 may set the SCM 108 to an initial SCM state by setting each of the parameters to an initial value.

For example, the set of parameters may include a set of a set of angles (e.g., Butler angles (also referred to as discrete Fourier transform (DFT) angles)) for a set of orthogonal beams. The test system 104 may set the SCM 108 to an initial SCM state by configuring the SCM 108 with the set of angles.

In some aspects, the set of parameters may include one or more correction factors. For example, the test system 104 may perform a calibration process to determine one or more correction factors for the SCM 108. The test system 104 may set the SCM 108 to an initial state by applying the correction factors to the SCM 108. For example, the test system 104 may multiple one or more coefficients of the SCM 108 by the correction factors.

In some aspects, the set of parameters may be configured based on a geographical location of a UE. For example, the SCM 108 may include a Butler matrix and one or more coefficients of the Butler matrix may be set to cause the Butler matrix to emulate a signal received by a UE at the geographical location.

In some aspects, the set of parameters may include a value of a counter and the initialization process may include setting the value of the counter to an initial value (e.g., 0). In some aspects, the counter may be used to select a reference port and/or a measured port, as described in greater detail below.

As shown by reference number 118, the test system 104 may perform an initialization process. In some aspects, the initialization process may include connecting the test system 104 to the base station 102.

In some aspects, the test system 104 may be connected to the base station 102 via one or more cables. For example, one or more cables may be used to connect the test system 104 to the antenna array 106 of the base station 102. In some aspects, the one or more cables may each be a radio frequency, phase stable cable. In some aspects, the one or more cables may have a maximum length. For example, the length of cable may less than, or equal to, a maximum length of 1 meter, 2 meters, or 3 meters, among other examples.

In some aspects, the test system 104 may be connected to the antenna array 106 via one or more fixed attenuators. For example, the antenna array 106 may include a set of antenna elements. A set of wired connections may be established (e.g., using one or more cables) between the antenna elements and one or more fixed attenuators. Another set of wired connections may be established between the one or more fixed attenuators and the test system 104.

In some aspects, the set of wired connections between the one or more fixed attenuators and the test system 104 may enable signals transmitted by the antenna array 106 to be received by the SCM 108. For example, as shown in FIG. 1D, the SCM 108 may include a quantity (A) of antenna ports 120 and each antenna element (not shown) of the antenna array 106 may be connected to the test system 104 (e.g., the SCM 108) via a respective antenna port 120 (e.g., antenna ports 0 through A−1, as shown in FIG. 1D) to enable a signal transmitted by an antenna element to be received by the SCM 108 via the antenna port 120 connecting that antenna element to the SCM 108.

In some aspects, the initialization process may optionally include connecting a UE to the test system 104. For example, as shown in FIG. 1D, a UE 122 may be connected to one or more beam ports of the SCM 108. In some aspects, the UE 122 may be a hardware and/or software component configured to emulate a UE located at a particular geographical location.

In some aspects, the UE 122 may be configured to connect to the base station 102, to cause the base station 102 to transmit a particular signal via a particular antenna element, as described in greater detail below.

In some aspects, the UE 122 may perform one or more actions based on receiving an emulated signal via the one or more beam ports of the SCM 108. In some aspects, the one or more actions may include extracting data from an emulated signal. In some aspects, the extracted data may include frequency domain symbol data. For example, the extracted data may include fast Fourier transform (FFT) symbol data.

In some aspects, the UE 122 may provide the extracted data to the emulated UE 110 and/or the analysis component 112. Additionally, or alternatively, the UE 122 may store the extracted data in the memory 114 and/or a memory associated with the UE 122.

In some aspects, the one or more actions may include determining a characteristic of the signal. For example, the UE may determine a reference signal received power (RSRP) associated with the signal, a signal-to-noise ratio (SNR) associated with the signal, a phase of the signal, and/or an amplitude of the signal, among other examples.

In some aspects, the UE 122 may provide data associated with the determined characteristic to the emulated UE 110 and/or the analysis component 112. Additionally, or alternatively, the UE 122 may cause the data associated with the determined characteristic to be stored in the memory 114 and/or a memory associated with the UE 122.

In some aspects, the initialization process may include performing a cell search. For example, the test system 104 (e.g., the emulated UE 110 and/or the UE 122) may perform a cell search to identify a cell associated with the base station 102, timing information, and/or other information associated with communicating with the base station 102.

In some aspects, to determine a residual error associated with the base station 102, the test system 104 may capture data via multiple antenna ports 120. In some aspects, data captured via a first antenna port 120 (e.g., a reference port 126) may be used as reference data. The test system 104 may utilize the reference data to normalize data (e.g., measurement data) captured via a second antenna port 120 (e.g., a measured port 128) and to generate a set of relative measurements associated with the second antenna port 120. In some aspects, normalizing the measurement data captured via the second antenna port 120 may compensate for an unknown absolute phase associated with the measurement data.

As shown in FIG. 1B, and by reference number 124, the test system 104 may select a reference port 126 and a measured port 128 based on performing the initialization process. In some aspects, the test system 104 may select the reference port 126 based on an initial value of a counter. For example, the antenna elements of the antenna array 106 may each be associated with a respective index value (e.g., 0 through A−1). The test system 104 may select an antenna port (e.g., antenna port 0, as shown in FIG. 1D) that is configured to receive a signal transmitted by an antenna element associated with an index value corresponding to an initial value of the counter.

In some aspects, the test system 104 may select a same port for the reference port 126 and the measured port 128. For example, the SCM 108 may be configured to capture data received via a pair of antenna ports 120, and the test system 104 may select a same port for the reference port 126 and the measured port 128 to enable the analysis component 112 to determine a set of reference measurements associated with the reference port 126.

In some aspects, the test system 104 (e.g., the analysis component 112) may determine a phase of a signal received via the reference port 126 and may utilize the determined phase as a phase reference to compensate for an unknown absolute phase of a signal received via the measured port 128, as described in greater detail below.

In some aspects, the test system 104 may select the measured port 128 based on a next value of the counter. For example, the test system 104 may increment a value of the counter based on selecting the reference port 126. The test system 104 may select an antenna port (e.g., antenna port 1, as shown in FIG. 1D) that is configured to receive a signal transmitted by an antenna element associated with an index value corresponding to the incremented value of the counter.

As shown in FIG. 1B, and by reference number 130, the test system 104 may set the SCM 108 based on selecting the reference port 126 and the measured port 128. In some aspects, the test system 104 may set the SCM 108 by configuring the SCM 108 to simultaneously receive signals transmitted by the base station 102 via the reference port 126 and the measured port 128.

For example, the SCM 108 may include a first switch (or a similar type of mechanism or configuration) that can be configured to cause the SCM 108 to receive a signal via the reference port 126 and output an emulated signal via a corresponding beam port. Similarly, the SCM 108 may include a second switch that can be configured to cause the SCM 108 to receive a signal via the measured port 128 and output an emulated signal via a corresponding beam port.

As shown in FIG. 1C, and by reference number 132, the base station 102 may transmit one or more signals via a set of antenna elements of the antenna array 106. In some aspects, the base station 102 may periodically transmit the signal. For example, the signal may be a synchronization signal block (SSB), an SSB burst, a signal transmitted as part of the SSB (e.g., a primary synchronization signal (PSS), a secondary synchronization signal (SSS), or a physical broadcast channel (PBCH)).

In some aspects, the signal may be a reference signal. For example, the signal may be a channel state information reference signal (CSI-RS), a tracking reference signal (TRS), a physical TRS (PTRS), or a demodulation reference signal (DMRS), among other examples.

In some aspects, the signal may include a communication transmitted via a physical downlink channel. For example, the signal may include a communication transmitted via a physical downlink control channel (PDCCH) or a physical downlink shared channel (PDSCH).

In some aspects, the base station 102 may transmit the signal based on receiving a request from the test system 104. For example, the test system 104 may transmit (e.g., via the emulated UE 110, the UE 122, or another UE associated with the test system 104) a request to the base station 102. In some aspects, the request may indicate a set of antenna elements via which the base station 102 is to transmit a signal, a type of signal (e.g., an SSB, a reference signal, or the like) to be transmitted by the base station 102, and/or a frequency at which the signal is to be transmitted, among other examples. The base station 102 may receive the request and may transmit the signal based on the request.

In some aspects, the base station 102 may transmit the signal based on receiving data from and/or having data to be transmitted to a UE connected to the base station. In some aspects, the UE may be the emulated UE 110, the UE 122, and/or another UE associated with the test system 104.

As shown by reference number 134, the test system 104 (e.g., the SCM 108, the emulated UE 110) may simultaneously capture data from signals received via the reference port 126 and the measured port 128 based on the base station 102 transmitting the one or more signals. For example, the base station 102 may transmit a signal via the antenna array 106, and the test system 104 may capture data associated with the signals transmitted via a first antenna element associated with the reference port 126 and a second antenna element associated with the measured port 128.

In some aspects, the test system 104 may be configured to analyze the captured data based on simultaneously capturing the data associated with the reference port 126 and the measured port 128, as described in greater detail below. Additionally, or alternatively, the test system 104 may analyze the captured data based on capturing data associated with each of the antenna ports 120.

In these aspects, as shown by reference number 136, the test system 104 may increment the value of the counter based on simultaneously capturing the data associated with the reference port 126 and the measured port 128. In some aspects, the test system 104 may determine whether data has been captured via all of the antenna ports 120 based on the incremented value of the counter. For example, the initial value of the counter may be set to zero, and the test system 104 may determine whether the incremented value of the counter is greater than one less than the quantity of antenna ports 120. As another example, the initial value of the counter may be set to one, and the test system 104 may determine whether the incremented value of the counter is greater than the quantity of antenna ports 120.

In some aspects, the test system 104 may determine that data has not been captured via all of the antenna ports 120. For example, the test system 104 may determine that the incremented value of the counter is less than, or equal to, one less than the quantity of antenna ports 120.

In these aspects, the test system 104 may utilize the same reference port 126 (e.g., antenna port 0, as shown in FIG. 1D) and may select a next measured port 128 based on the incremented value of the counter. For example, as shown by reference number 128-1, the test system 104 may select a third antenna port 120 (e.g., antenna port 2, as shown in FIG. 1D) as the next measured port 128 based on the incremented value of the counter.

In some aspects, the test system 104 may continue in a manner similar to that described above for each antenna port 120. For example, as indicated by the dashed lines in FIG. 1D, the test system 104 may select each subsequent antenna port 120 based on an incremented value of the counter to simultaneously capture via the reference port 126 and each antenna port 120.

In some aspects, the base station 102 may transmit a signal (e.g., an SSB) that can be analyzed without connecting a UE (e.g., UE 122) to the base station. In some aspects, the base station 102 may transmit a signal via a communication channel that is present based on a UE being connected to the base station 102.

In these aspects, the test system 104 may cause the UE 122 to be connected to the base station 102. In some aspects, the UE 122 may be connected to a channel model 138 associated with the SCM 108. The channel model 138 may be configured to receive a signal from the UE 122 (e.g., via a beam port of the SCM 108) and to generate a first emulated UE signal based on the received signal. In some aspects, the first emulated UE signal may correspond to a signal transmitted by a UE located in a first spatial position that causes the base station 102 to transmit a signal via a first set of antenna elements.

In some aspects, the test system 104 may cause the channel model 138 to be reconfigured to generate a second emulated UE signal based on capturing data via a set of antenna ports 120 associated with the first set of antenna elements. In some aspects, the second emulated UE signal may correspond to a signal transmitted by a UE located in a second spatial position that causes the base station 102 to transmit a signal via a second set of antenna elements. One or more antenna elements included in the second set of antenna elements may not be included in the first set of antenna elements. In some aspects, reconfiguring the channel model 130 and/or providing the base station 102 with the emulated UE signals may enable the test system 104 to determine an effect of a movement of a UE on the residual error determined by the test system 104.

In some aspects, the test system 104 may continue in a similar manner until data has been captured via all of the antenna ports 120.

In some aspects, the test system 104 may determine that data has been captured via all of the antenna ports 120. For example, the test system 104 may determine that the incremented value of the counter is greater than one less than the quantity of antenna ports 120. In these aspects, as shown by reference number 140, the test system 104 (e.g., the analysis component 112) may analyze the captured data.

In some aspects, the test system 104 may analyze the data captured via each measured port 128 based on the data that was simultaneously captured via the reference port 126. For example, the SCM 108 may receive, via the reference port 126, a signal transmitted by the first antenna element included in the antenna array 106 of the base station 102. The SCM 108 may generate a first emulated signal based on the signal received via the reference port 126. The SCM 108 may output the first emulated signal to the emulated UE 110 (and/or the UE 122) via a reference channel 142 established between a first beam port of the SCM 108 and a first input port of the emulated UE 110 (and/or the UE 122).

Similarly, the SCM 108 may receive, via the measured port 128, a signal transmitted by the second antenna element included in the antenna array 106 of the base station 102. The SCM 108 may generate a second emulated signal based on the signal received via the measured port 128. The SCM 108 may output the second emulated signal to the emulated UE 110 (and/or the UE 122) via a measured channel 144 established between a second beam port of the SCM 108 and a second input port of the emulated UE 110 (and/or the UE 122).

In some aspects, the SCM 108 may output the first and second emulated signals to the emulated UE 110. The emulated UE 110 may receive the first and second emulated signals and may extract a portion of the emulated signals (e.g., a portion of data).

In some aspects, the portion of data may include FFT symbol data. For example, the base station 102 may utilize orthogonal frequency division multiplexing (OFDM) to transmit the signal, and the emulated UE 110 may extract FFT symbol data based on OFDM being used to transmit the signal.

In some aspects, the portion of data may include time domain data. For example, the emulated UE 110 may extract time domain data from the emulated signal based on the base station 102 transmitting the signals via a particular communication channel.

In some aspects, the portion of data may include channel estimates for a particular communication channel. For example, the emulated UE 110 may extract data associated with channel estimates from the emulated signals based on the base station 102 transmitting the signals via a PDSCH.

In some aspects, using the emulated UE 110 to extract the portion of data may reduce a computational complexity associated with analyzing the data and/or an amount of data analyzed by the analysis component 112, thereby reducing a computational complexity associated with an analysis of the captured signals. In some aspects, to connect to the base station 102, the emulated UE 110 may determine information associated with the base station 102 and/or information associated with a transmission of a captured signal. For example, the emulated UE may determine a communication channel via which the signals are transmitted, an initial frequency associated with a transmission of the data, and/or timing information associated with a transmission of the data. In some aspects, the emulated UE 110 may utilize the information associated with the base station 102 and/or the information associated with a transmission of the captured signals to extract a minimum amount of data (e.g., FFT symbol data for signals transmitted via a 5G New Radio (NR) wireless communication network) needed to perform an analysis of the captured signals.

In some aspects, the emulated UE 110 may provide the portion of the data to the analysis component 112. For example, the emulated UE 110 may provide a portion of data associated with the signal received via the reference channel 142 (e.g., x0, as shown in FIG. 1D) to the analysis component 112 via a first communication channel established between the emulated UE 110 and the analysis component 112, and may provide a portion of data associated with the signal received via the measured channel 144 (e.g., x1, as shown in FIG. 1D) to the analysis component 112 via a second communication channel established between the emulated UE 110 and the analysis component 112. Additionally, or alternatively, the emulated UE 110 may store the portion of data associated with the signal received via the reference channel 142 and the portion of data associated with the signal received via the measured channel 144 in the memory 114.

In some aspects, the analysis component 112 may analyze the portions of the data based on receiving the portions of the data from the emulated UE 110. As an example, the signals transmitted by the base station 102 may be a PSS and/or an SSS associated with each SSB in an SSB burst. In some aspects, the test system 104 may be configured to utilize the PSS and/or the SSS based on the base station 102 being configured to periodically (e.g., every 20 ms) transmit an SSB via multiple different communication channels and/or multiple different antenna elements. Additionally, the base station 102 may be configured to apply a same set of beam weights to each of the periodic transmissions of the SSB, thereby enabling the test system 104 to capture (via the reference port 126 and each one of the antenna ports 120) different pairs of signals having the same phase relationship (e.g., based on the same set of beam weights being applied) in a sequential manner.

In some aspects, the emulated UE 110 may receive the emulated signals from the SCM 108 and may extract a portion of data x0 from the emulated signal associated with the reference port 126 and a portion of data x1 from the emulated signal associated with the measured port 128. In some aspects, the emulated UE 110 may provide the portion of data x0 and the portion of data x1 to the analysis component 112 based on extracting the portions of data from the emulated signals (rather than, or in addition to, storing the portions of data in the memory 114).

In some aspects, the portion of data x0 and the portion of data x1 may be frequency domain symbol data. In these aspects, the analysis component 112 may calculate the portion of data x1 normalized to the portion of data x0. As an example, a complex symbol measured on an antenna port a, where a∈{0, A−1}, routed to beam port b, where b ∈{0, B−1}, may be designated x_{a,b}(k, n), k is the subcarrier index associated with the transmitted signal, and n is the discrete time index associated with the transmitted signal. In some aspects, the analysis component 112 may calculate the data normalized to a phase reference antenna a_{ref} (e.g., the reference port 126) based on:

$${\overline{x}}_{a , n} ( k ) = \frac{{x}_{a , {b}_{t e s t}} ( k , n )}{{x}_{{a}_{ref} , {b}_{ref}} ( k , n )} , \qquad ( equation 1 ) ,$$

where b_{ref} is the beam port associated with the reference port 126 and bₜₑₛₜ is the beam port associated with the measured port 128.

In some aspects, the analysis component 112 may re-normalize the portion of data x1 to one or more different reference ports 126. For example, the measurements for antenna ports a₁ and a₂ may be performed at subcarrier index n₁ and subcarrier index n₂, respectively. The analysis component 112 may re-normalize the portion of data x1 using the following equation:

$${\overline{\overline{x}}}_{( {a}_{1} , {n}_{1 )}}^{( {a}_{2} , {n}_{2} )} ( k ) = \frac{{\overline{x}}_{{a}_{2} , {n}_{2}} ( k )}{{\overline{x}}_{{a}_{1} , {n}_{1}} ( k )} = \frac{{x}_{{a}_{2} , {b}_{t e s t}} ( k , {n}_{2} )}{{x}_{{a}_{r e f} , {b}_{r e f}} ( k , {n}_{2} )} \times \frac{{x}_{{a}_{r e f} , {b}_{r e f}} ( k , {n}_{1} )}{{x}_{{a}_{1} , {b}_{t e s t}} ( k , {n}_{1} )} . \qquad ( equation 2 )$$

In some aspects, the beam weights (w(k, n)=(w₀(k, n), w₁(k, n), . . . , w_{A-1}(k, n))) applied to the transmitted signals may be known by the test system 104 (e.g., the analysis component 112). For example, the base station 102 (and/or another device) may provide the beam weights to the test system 104 during the initialization process described above with respect to reference number 118. In these aspects, equations 1 and 2, described above, can be further re-normalized by the beam weights.

In some aspects, further re-normalizing equations 1 and 2 by the beam weights may enable the analysis component 112 to extract additional information about the calibration accuracy and stability of the test system 104. In some aspects (e.g., for simplicity of notation and without loss of generality), (k, n) may be replaced by w in the following equations:

$${\hat{x}}_{a , n , {w}_{a}} ( k ) = \frac{{x}_{a , {b}_{t e s t}} ( k , n )}{{x}_{{a}_{r e f} , {b}_{r e f}} ( k , n )} \times \frac{{w}_{{a}_{ref}}}{{w}_{a}} , \qquad ( equation 3 )$$

$${\hat{\hat{x}}}_{{a}_{1} , {n}_{1} , {w}_{{a}_{1}}}^{{a}_{2} , {n}_{2} , {w}_{{a}_{2}}} ( k ) = \frac{{\hat{x}}_{{a}_{2} , {n}_{2} , {w}_{{a}_{2}}} ( k )}{{\hat{x}}_{{a}_{1} , {n}_{1} , {w}_{{a}_{1}}} ( k )} = \frac{{x}_{{a}_{2} , {b}_{t e s t}} ( k , {n}_{2} )}{{x}_{{a}_{r e f} , {b}_{r e f}} ( k , {n}_{2} )} \times \frac{{x}_{{a}_{r e f} , {b}_{r e f}} ( k , {n}_{1} )}{{x}_{{a}_{1} , {b}_{t e s t}} ( k , {n}_{1} )} \times \frac{{w}_{{a}_{1}}}{{w}_{{a}_{2}}} . \qquad ( equation 4 )$$

In some aspects, the analysis component 112 may use correlation to extract the complex gain (g) associated with the portion of data x1. In some aspects, the portion of the data x1 may be represented as:

$$x 1 ( k ) = gx 0 ( k ) . \qquad ( equation 5 )$$

The analysis component 112 may multiply both sides of the equation by the conjugate of the portion of data x0 (represented by x0*), resulting in:

$$x {0}^{*} ( k ) x 1 ( k ) = gx {0}^{*} ( k ) x 0 ( k ) . \qquad ( equation 6 )$$

The analysis component 112 may calculate a sum across all values of k and rearrange the equation, resulting in:

$$\hat{g} = \frac{\sum x {0}^{*} ( k ) x 1 ( k )}{\sum x {0}^{*} ( k ) x 0 ( k )} , \qquad ( equation 7 )$$

which may correspond to the least square method (LSM) estimate of the complex gain.

In some aspects, the use equations 5-7 to determine the LSM estimate of the complex gain may average out the effects of uncorrelated noise on the portion of data x0 and the portion of data x1. In some aspects, the analysis component 112 may utilize equations 5-7 (rather than equations 1-4) based on a type of signal transmitted by the base station 102 (e.g., a PBCH) and/or a magnitude of the portion of data x0 (e.g., when the magnitude satisfies (e.g., is less than) a threshold).

In some aspects, the analysis component 112 may re-normalize the portion of data x1 to one or more different reference ports 126 for each polarization associated with the transmitted signals. For example, the analysis component 112 may re-normalize the portion of data x1 to one or more different reference ports 126 for each polarization associated with the transmitted signals in a manner similar to that described above (e.g., using equations 1-4).

In some aspects, the analysis component 112 may process the normalized data to analyze amplitude and/or phase errors associated with a corresponding antenna port 120 (e.g., the antenna port 120 corresponding to the measured port 128). In some aspects, the analysis component 112 may average the amplitude and/or phase errors over time, frequency, or time and frequency.

In some aspects, the analysis component 112 may process the normalized data to determine an average power difference across the measured ports 128 relative to reference port 126. In some aspects, the analysis component 112 may determine the average power difference based on the following equation:

$$10 {log}_{10} ( E [ {\vert {\overline{x}}_{a , n} ( k ) \vert}^{2} ] ) ,$$

where E is the expected value/average. In some aspects, the test system 104 may determine an estimated value of the average power difference over time and/or subcarrier index, with or without averaging.

In some aspects, the analysis component 112 may process the normalized data to determine normalized phases with respect to the reference port 126. In some aspects, the analysis component 112 may determine the normalized phases based on the following equation:

$$E [ angle ( {\overline{x}}_{a , n} ( k ) ) ] .$$

In some aspects, the analysis component 112 may process the normalized data to determine progressive phase values between two antenna ports 120. In some aspects, the analysis component 112 may determine the progressive phase values between two antenna ports 120 based on the following equation:

$$E [ angle ( {\overline{\overline{x}}}_{( {a}_{1} , {n}_{1 )}}^{( {a}_{2} , {n}_{2} )} ( k ) ) ] .$$

In some aspects, the analysis component 112 may process the normalized data to estimate a beam former of the base station 102. In some aspects, the analysis component 112 may determine information associated with the beam former used by the base station 102 based on a phase difference between the beam weights used by the base station 102. In some aspects, the phase difference between the beam weights may be determined based on the following equation:

$$Δ {ϕ}_{{a}_{2} , {a}_{1}} = angle ( \frac{{w}_{{a}_{2}}}{{w}_{{a}_{1}}} ) .$$

In some aspects, the analysis component 112 may determine phase errors between two antenna ports 120 based on the beam weights applied to the transmitted signals by the base station 102. In some aspects, the analysis component 112 may determine the phase errors between two antenna ports 120 based on the following equation:

$${e}_{{a}_{2} , {a}_{1}} = angle ( {\hat{\hat{x}}}_{{a}_{1} , {n}_{1} , {w}_{{a}_{1}}}^{{a}_{2} , {n}_{2} , {w}_{{a}_{2}}} ( k ) ) .$$

The analysis component 112 may determine that, when no phase errors are present,

$${\overline{\overline{x}}}_{( {a}_{1} , {n}_{1 )}}^{( {a}_{2} , {n}_{2} )} ( k ) = \frac{{w}_{{a}_{2}}}{{w}_{{a}_{1}}} and$$

$${e}_{{a}_{2} , {a}_{1}} = angle ( {\hat{\hat{x}}}_{{a}_{1} , {n}_{1} , {w}_{{a}_{1}}}^{{a}_{2} , {n}_{2} , {w}_{{a}_{2}}} ( k ) ) = 0 .$$

The analysis component 112 may determine the phase errors between two antenna ports 120 based on differences between results of performing the calculations on the normalized data (e.g., with phase errors being present) and results of the calculations associated with no phase errors being present.

In some aspects, the beam weights applied to the transmitted signals by the base station 102 may be unknown to the test system 104. In some aspects, the analysis component 112 may analyze the captured data to show repeatability of the residual errors, drift, noise, stability, and/or errors such as unconnected signals, among other examples.

In some aspects, a pair of signals captured via the reference port 126 and a measured port 128 may be symmetric. For example, the pair of signals may be symmetric on the horizontal domain, symmetric on the horizontal domain with no beam tilt in the vertical domain, symmetric on the horizontal and vertical domains, or the symmetry may take the form of complex-conjugate weights. In these aspects, the analysis component 112 may determine that the beam weights for the pair of signals are complex conjugates of each other based on the pair of signals being symmetric, which may be represented as:

$${w}_{1} = ( 1 , {e}^{j {θ}_{2}} , … , {e}^{j {θ}_{N}} ) ; and$$

$${w}_{2} = ( 1 , {e}^{- j {θ}_{2}} , … , {e}^{- j {θ}_{N}} ) ,$$

where w₁ is the beam weights associated with the signal captured via the reference port 126, and w₂ is the beam weights associated with the signal captured via the measured port 128.

In some aspects, the analysis component 112 may estimate an error associated with an antenna via which the signal captured via the measured port 128 is transmitted based on the beam weights for the pair of signals are complex conjugates of each other. In some aspects, the analysis component 112 may estimate the error associated with an antenna (n) based on:

$$\{ \begin{matrix}{y}_{1 , n} = {e}^{j ( {θ}_{n} + {δ}_{n} )} \\ {y}_{2 , n} = {e}^{j ( - {θ}_{n} + {δ}_{n} )} \\ {δ}_{n} = ∠ ( \sqrt{{y}_{1 , n} {y}_{2 , n}} ) = ∠ ( \sqrt{{e}^{j ( {θ}_{n} + {δ}_{n} )} {e}^{j ( - {θ}_{n} + {δ}_{n} )}} )\end{matrix} .$$

FIG. 1E illustrates a graph of measured relative phase per antenna port and a graph of phase error per antenna port based on two symmetric beams. In some aspects, the graph of the measured relative phase per antenna port shows the measured relative phase differences (e.g., normalized by the signal received via the reference port 126) for each antenna port. As shown in FIG. 1E, the signal captured via the reference port 126 may be a first SSB (e.g., SSB1, as shown) and the signal captured via the measured port 128 may be a second SSB (e.g., SSB2, as shown). The graph of the phase error per antenna port may illustrate the error estimated for each antenna port using the equations described above.

In some aspects, the analysis component 112 may determine the residual error based on a symmetry in the signals transmitted by the base station 102. In some aspects, the analysis component 112 may determine that the signals are transmitted in directions that are symmetric in the azimuth and elevation directions. The analysis component 112 may determine that the signals have equal and opposite phase ramps across the antenna elements in the horizontal and vertical directions based on the signals being transmitted in the directions that are symmetric in the azimuth and elevation directions. The analysis component 112 may eliminate or compensate for the unknown beam weights and calculate the residual errors based on the signals having equal and opposite phase ramps across the antenna elements in the horizontal and vertical directions.

In some aspects, the base station 102 may transmit repetitions of signals (e.g., SSBs) using beam weights that are progressively increasing in the horizonal and vertical domains (e.g., with no amplitude tapering). In some aspects, the initial calibration of the test system 104 may enable an phase error associated with the test system 104 to be approximately equal to zero. In some aspects, for each repetition of the signals, the analysis component 112 may determine the relative progressive phases between two adjacent antennas on the horizontal and vertical domains. In some aspects, the analysis component 112 may determine a beamforming weight for each signal based on a difference between the relative progressive phases between the two adjacent antennas.

As an example, the for a set of frequency domain symbols, the complex symbol measured on antenna port a ∈{0, A−1}, routed to beam port b ∈{0, B−1}, may be designated x_{a,b}(k, n), where A, B, k, n are the quantity of antenna ports 120, the quantity of beam ports of the SCM 108 (e.g., the quantity of measured ports 128), the subcarrier index, and discrete time index, respectively. In some aspects, the analysis component 112 may calculate data normalized to a phase reference antenna (a_{ref}) based on:

$${\overline{x}}_{a , n} ( k ) = \frac{{x}_{a , {b}_{test}} ( k , n )}{{x}_{{a}_{r e f} , {b}_{r e f}} ( k , n )} , \qquad ( equation 1 )$$

where bₜₑₛₜ is the beam port that is used for a testing port, and b_{ref} is the beam port used as a reference port.

In some aspects, the analysis component 112 may, optionally, re-normalize the data to one or more reference antenna ports. In some aspects, the analysis component 112 may re-normalize the data separately for each polarization.

In some aspects, the measurement for antenna ports a₁ and a₂ may be performed at n₁ and n₂, respectively, and the analysis component 112 may determine the progressive phase values between the antenna ports a₁ and a₂ using the following equation:

$${\overline{\overline{x}}}_{( {a}_{1} , {n}_{1 )}}^{( {a}_{2} , {n}_{2} )} ( k ) = \frac{{\overline{x}}_{{a}_{2} , {n}_{2}} ( k )}{{\overline{x}}_{{a}_{1} , {n}_{1}} ( k )} = \frac{{x}_{{a}_{2} , {b}_{t e s t}} ( k , {n}_{2} )}{{x}_{{a}_{r e f} , {b}_{r e f}} ( k , {n}_{2} )} \times \frac{{x}_{{a}_{r e f} , {b}_{r e f}} ( k , {n}_{1} )}{{x}_{{a}_{1} , {b}_{t e s t}} ( k , {n}_{1} )} . \qquad ( equation 2 )$$

In some aspects, the analysis component 112 may determine the progressive phase values using linear regression or averaging. For example, the analysis component 112 may determine the progressive phase values based on the following equation:

$$E [ angle ( {\overline{\overline{x}}}_{( {a}_{1} , {n}_{1 )}}^{( {a}_{2} , {n}_{2} )} ( k ) ) ] .$$

In some aspects, the analysis component 112 may determine the progressive phase values using filtering or an estimation method for determining a DC value from noisy data. For example, the analysis component 112 may determine that a constant phase value can be treated like a DC and that a calibration error can be treated like noise and may use a filtering or estimation method for determining a DC to estimate a constant phase value. FIGS. 1F-1I illustrate example estimations of progressive phase values for eight SSBs transmitted by the base station 102.

In some aspects, the base station 102 may track a position of a UE connected to the base station 102 and the test system 104 may cause the base station 102 to transmit signals in directions that are symmetric in the azimuth and elevation directions. In some aspects, the test system 104 may reconfigure the component model 138 to generate emulated UE signals corresponding to signals transmitted by a UE located at different spatial positions (e.g., with symmetry) with respect to the base station 102. As an example, a spatial position of the UE may be indicated using the notation: (azimuth, elevation), where azimuth and elevation are provided in degrees. The test system 104 may reconfigure the component model 138 to generate emulated UE signals corresponding to signals transmitted by a UE located at (−20, −20), (20, −20), (−20, 20), and (20, 20).

In some aspects, the test system 104 may utilize additional and/or different types of signals to determine the residual errors. For example, the transmitted signal captured by the test system 104 may be an SSB (or a portion thereof) and the test system 104 may utilize a CSI-RS to obtain additional data for determining the residual errors. In some aspects, the additional and/or different types of signals may have symmetries that can be utilized, either alone or in conjunction with data captured from the SSB, to eliminate unknown beam weights and/or determine the residual errors.

In some aspects, the test system 104 (e.g., the analysis component 112) may analyze data captured across a bandwidth of the communication channel via which it was transmitted to estimate a frequency response difference between different antenna ports 120. In some aspects, the analysis component 112 may estimate a phase slope based on the estimated frequency response difference. In some aspects, the analysis component 112 may estimate an inter-antenna delay based on the estimated phase slope.

In some aspects, the analysis component 112 may average the determined and/or estimated data across multiple repetitions of the process described above and/or across a bandwidth of the communication channel via which the base station 102 transmitted the signals.

In some aspects, the analysis component 112 may analyze the portions of the data based on signals being captured via all of the antenna ports 120. For example, the test system 104 may provide an indication to the analysis component 112, and the analysis component 112 may determine that signals have been captured via all of the antenna ports 120 based on receiving the indication. In some aspects, the analysis component 112 may query the memory 114 to obtain sets of portions of data extracted from sets (e.g., pairs) of emulated signals. The sets of emulated signals may be associated with sets of simultaneously captured signals captured via the reference port 126 and the measured port 128, and the analysis component 112 may analyze the sets of portions of data in a manner similar to that described above.

In some aspects, the test system 104 may assess a performance of the base station 102 and/or the test system 104. In some aspects, the result may correspond to a residual error associated with the base station 102 and/or the test system 104. In some aspects, the test system 104 may configure (or re-configure) the SCM 108 based on the residual error. For example, the test system 104 may multiply one or more coefficients of the SCM 108 by the residual error.

In some aspects, the test system 104 may output the results to the base station 102. For example, the test system 104 may output the results to the base station 102 to enable the base station 102 to compensate for residual error associated with the base station 102. In some aspects, the base station 102 may compensate for the residual error by modifying one or more transmission parameters. For example, the base station 102 may modify the beam weights being applied to particular signals, a power (e.g., a transmit power) at which a signal is transmitted by the base station 102, a modulation and coding scheme (MCS) associated with transmitting a signal, and/or a frequency at which a signal is transmitted, among other examples.

In some aspects, the test system 104 may store a result of analyzing the portions of data (e.g., in memory 114). Additionally, or alternatively, the test system 104 may cause the result to be displayed by a display of the test system 104 and/or a display of a device associated with the test system 104 (e.g., the UE 122 and/or another UE).

FIG. 1J illustrates an example user interface via which the result may be displayed. In some aspects, the user interface may be used to configure the test system 104. For example, the user interface may be configured to allow a user to initiate the initialization process, select the reference port 126 (e.g., antenna port 0, as shown in FIG. 1J), configure an order in which the antenna ports 120 are selected as the measured ports 128, configure the emulated UE 110, input the beam weights being applied by the base station 102, configure the data to be displayed by the user interface (e.g., Total SS-RSRP, Antenna Port, Level (db), and Phase (deg), as shown in FIG. 1J), configure a periodicity at which the data is to be updated (e.g., every second, every five seconds, every ten seconds, every minute, or the like), antenna ports to be highlighted (e.g., the antenna corresponding to the reference port 126, as shown in FIG. 1J), results to be highlighted (e.g., results within and/or outside of 1 standard deviation, results that satisfy a threshold, results within a particular range of values, and/or the like), and/or a color (e.g., gray shading to highlight the antenna port selected as the reference port 126, as shown in FIG. 1J) and/or a pattern used to highlight the results (e.g., diagonal lines, as shown in FIG. 1J), among other examples.

As indicated above, FIGS. 1A−1J are provided as an example. Other examples may differ from what is described with regard to FIGS. 1A−1J. The number and arrangement of devices shown in FIGS. 1A−1J are provided as an example. In practice, there may be additional devices, fewer devices, different devices, or differently arranged devices than those shown in FIGS. 1A−1J. Furthermore, two or more devices shown in FIGS. 1A−1J may be implemented within a single device, or a single device shown in FIGS. 1A−1J may be implemented as multiple, distributed devices. Additionally, or alternatively, a set of devices (e.g., one or more devices) shown in FIGS. 1A−1J may perform one or more functions described as being performed by another set of devices shown in FIGS. 1A−1J.

FIG. 2 is a diagram of an example environment 200 in which systems and/or methods described herein may be implemented. As shown in FIG. 2, environment 200 may include a test system 104, a base station 102, a UE 122, and a network 210. Devices of environment 200 may interconnect via wired connections, wireless connections, or a combination of wired and wireless connections.

Test system 104 includes one or more devices capable of communicating with base station 102 and/or a network (e.g., network 210), such as to perform processing of a signal produced by base station 102. Test system 104 may communicate with base station 102 by a wired connection, as described elsewhere herein. In some implementations, test system 104 may wirelessly communicate with base station 102.

Test system 104 may include a beamforming network, a feedback component, and/or a test component as described elsewhere herein. The beamforming network may include an analog beamforming network that outputs a signal associated with a beam direction, as described elsewhere herein. The feedback component may include a passive radio frequency (RF) component, such as an RF coupler, that outputs a feedback signal based on an output signal of the beamforming network or a calibration signal of a calibration component of the base station 102, as described elsewhere herein. The test component may include one or more devices capable of receiving, generating, storing, processing, and/or providing information associated with a signal, such as an RF signal (e.g., an output signal of the beamforming network). For example, the test component may include a communication and/or computing device, such as a mobile phone (e.g., a smart phone, a radiotelephone, etc.), a laptop computer, a tablet computer, a handheld computer, a desktop computer, a gaming device, a wearable communication device (e.g., a smart wristwatch, a pair of smart eyeglasses, etc.), or a similar type of device.

Base station 102 includes one or more devices capable of communicating with a UE using a cellular radio access technology (RAT). For example, base station 102 may include a base transceiver station, a radio base station, a node B, an evolved node B (eNB), a gNB, a base station subsystem, a cellular site, a cellular tower (e.g., a cell phone tower or a mobile phone tower), an access point, a transmit receive point (TRP), a radio access node, a macrocell base station, a microcell base station, a picocell base station, a femtocell base station, or a similar type of device. Base station 102 may transfer traffic between a UE (e.g., using a cellular RAT), other base stations 102 (e.g., using a wireless interface or a backhaul interface, such as a wired backhaul interface), and/or network 210. Base station 102 may provide one or more cells that cover geographic areas. Some base stations 102 may be mobile base stations. Some base stations 102 may be capable of communicating using multiple RATs.

In some implementations, base station 102 may perform scheduling and/or resource management for UEs covered by base station 102 (e.g., UEs covered by a cell provided by base station 102). In some implementations, base stations 102 may be controlled or coordinated by a network controller, which may perform load balancing and/or network-level configuration. The network controller may communicate with base stations 102 via a wireless or wireline backhaul. In some implementations, base station 102 may include a network controller, a self-organizing network (SON) module or component, or a similar module or component. In other words, a base station 102 may perform network control, scheduling, and/or network management functions (e.g., for other base stations 102 and/or for uplink, downlink, and/or sidelink communications of UEs covered by the base station 102). In some implementations, base station 102 may include a central unit and multiple distributed units. The central unit may coordinate access control and communication with regard to the multiple distributed units. The multiple distributed units may provide UEs and/or other base stations 102 with access to network 210.

In some implementations, base station 102 may be capable of MIMO communication (e.g., beamformed communication). In some implementations, base station 102 may include a calibration component for phase calibration of signals produced or received by base station 102, as described elsewhere herein. In a testing scenario, one or more antenna elements (e.g., an antenna array) of base station 102 may be disconnected, and base station 102 may be connected to a test panel, as described elsewhere herein.

UE 122 may include one or more devices capable of communicating with base station 102 and/or a network (e.g., network 210). For example, UE 122 may include a wireless communication device, a radiotelephone, a personal communications system (PCS) terminal (e.g., that may combine a cellular radiotelephone with data processing and data communications capabilities), a smart phone, a laptop computer, a tablet computer, a personal gaming system, user equipment, and/or a similar device. UE 122 may be capable of communicating using uplink (e.g., UE to base station) communications, downlink (e.g., base station to UE) communications, and/or sidelink (e.g., UE-to-UE) communications. In some implementations, UE 122 may include a machine-type communication (MTC) UE, such as an evolved or enhanced MTC (eMTC) UE. In some implementations, UE 122 may include an Internet of Things (IoT) UE, such as a narrowband IoT (NB-IoT) UE.

Network 210 includes one or more wired and/or wireless networks. For example, network 210 may include a cellular network (e.g., a long-term evolution (LTE) network, a code division multiple access (CDMA) network, a 3G network, a 4G network, a 5G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or a combination of these or other types of networks.

The quantity and arrangement of devices and networks shown in FIG. 2 are provided as one or more examples. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with error estimation with an inline SCM. The device 300 corresponds to one or more of the base station 102, the test system 104, and/or the UE 122. In some implementations, the base station 102, the test system 104, and/or the UE 122 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random access memory (RAM), read only memory (ROM), a hard disk drive, and/or another type of memory (e.g., a flash memory, a magnetic memory, and/or an optical memory). In some aspects, the memory 330 may correspond to the memory 114. In some aspects, the memory 330 may be different or separate from the memory 114.

The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

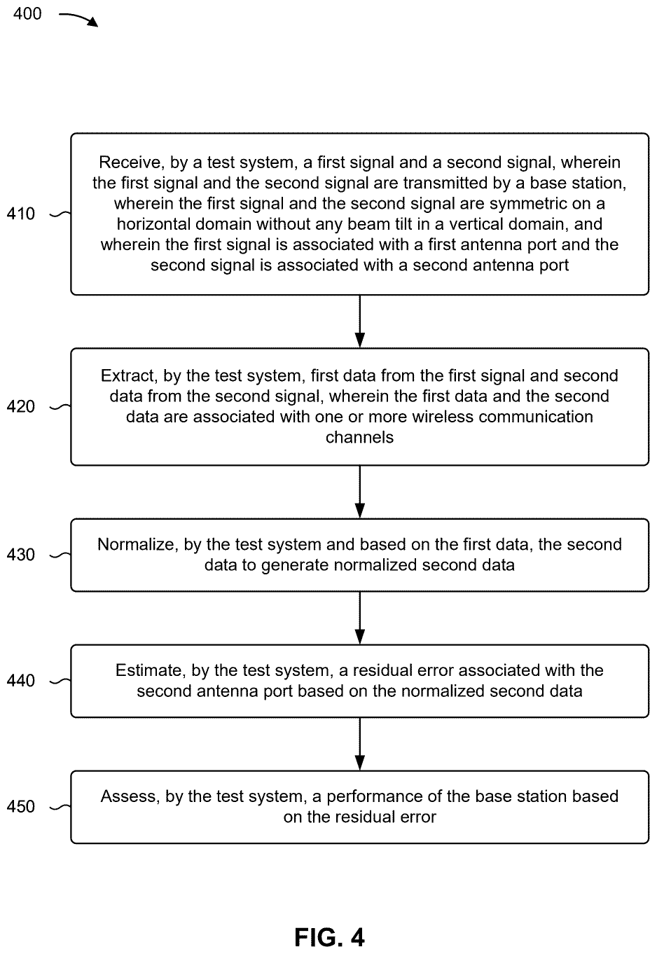

FIG. 4 is a flowchart of an example process 400 associated with error estimation with inline spatial channel model. One or more process blocks of FIG. 4 are performed by a test system (e.g., test system 104) and/or by another device or a group of devices separate from or including the test system, such as a base station (e.g., base station 102) and/or a UE (e.g., UE 122). Additionally, or alternatively, one or more process blocks of FIG. 4 may be performed by one or more components of device 300, such as processor 320, memory 330, input component 340, output component 350, and/or communication component 360.

As shown in FIG. 4, process 400 includes receiving a first signal and a second signal, wherein the first signal and the second signal are transmitted by a base station, wherein the first signal and the second signal are symmetric on a horizontal domain without any beam tilt in a vertical domain, and wherein the first signal is associated with a first antenna port and the second signal is associated with a second antenna port (block 410). For example, the test system may receive a first signal and a second signal, wherein the first signal and the second signal are transmitted by a base station, wherein the first signal and the second signal are symmetric on a horizontal domain without any beam tilt in a vertical domain, and wherein the first signal is associated with a first antenna port and the second signal is associated with a second antenna port, as described above.

As further shown in FIG. 4, process 400 includes extracting first data from the first signal and second data from the second signal, wherein the first data and the second data are associated with one or more wireless communication channels (block 420). For example, the test system may extract first data from the first signal and second data from the second signal, wherein the first data and the second data are associated with one or more wireless communication channels, as described above.

As further shown in FIG. 4, process 400 includes normalizing the second data to generate normalized second data (block 430). For example, the test system may normalize the second data to generate normalized second data, as described above.

As further shown in FIG. 4, process 400 includes estimating a residual error associated with the second antenna port based on the normalized second data (block 440). For example, the test system may estimate a residual error associated with the second antenna port based on the normalized second data, as described above.

As further shown in FIG. 4, process 400 includes assessing a performance of the base station based on the residual error (block 450). For example, the test system may assess a performance of the base station based on the residual error, as described above.

Process 400 may include additional aspects, such as any single aspect or any combination of aspects described below and/or in connection with one or more other processes described elsewhere herein.

In a first aspect, estimating the residual error associated with the second antenna port based on the normalized second data comprises estimating the residual error associated with the second antenna port based on the normalized second data and based on a first set of beam weights associated with the first signal being a complex conjugate of a second set of beam weights associated with the second signal.

In a second aspect, alone or in combination with the first aspect, the residual error associated with the second antenna port comprises one or more of a residual amplitude error or a residual phase error.

In a third aspect, alone or in combination with one or more of the first and second aspects, process 400 includes providing information indicating the residual error associated with the second antenna port to the base station.

In a fourth aspect, alone or in combination with one or more of the first through third aspects, extracting the first data and the second data comprises extracting one or more first FFT symbols from the first signal, and extracting one or more second FFT symbols from the second signal.

In a fifth aspect, alone or in combination with one or more of the first through fourth aspects, one or more of the first signal or the second signal comprises a synchronization signal block.

In a sixth aspect, alone or in combination with one or more of the first through fifth aspects, estimating the residual error comprises determining a phase difference between the first signal and the second signal based on the normalized second data.

In a seventh aspect, alone or in combination with one or more of the first through sixth aspects, process 400 includes receiving the first signal and a third signal, wherein the third signal is associated with a third antenna port, extracting the first data from the first signal and third data from the third signal, wherein the first data and the third data are associated with the one or more wireless communication channels, normalizing, based on the first data, the third data to generate normalized third data, estimating a residual error associated with the third antenna port based on the normalized third data, and assessing the performance of the base station based on the residual error associated with the second antenna port and the residual error associated with the third antenna port.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

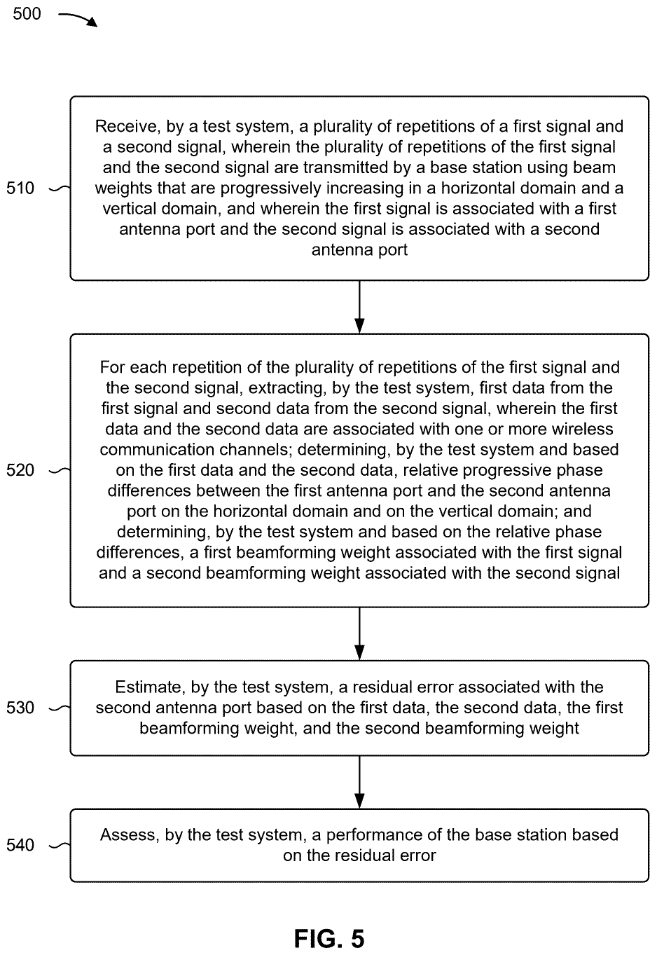

FIG. 5 is a flowchart of an example process 500 associated with error estimation with inline spatial channel model. One or more process blocks of FIG. 5 are performed by a test system (e.g., test system 104) and/or by another device or a group of devices separate from or including the test system, such as a base station (e.g., base station 102) and/or a UE (e.g., UE 122). Additionally, or alternatively, one or more process blocks of FIG. 5 may be performed by one or more components of device 300, such as processor 320, memory 330, input component 340, output component 350, and/or communication component 360.

As shown in FIG. 5, process 500 includes receiving a plurality of repetitions of a first signal and a second signal, wherein the plurality of repetitions of the first signal and the second signal are transmitted by a base station using beam weights that are progressively increasing in a horizontal domain and a vertical domain, and wherein the first signal is associated with a first antenna port and the second signal is associated with a second antenna port (block 510). For example, the test system may receive a plurality of repetitions of a first signal and a second signal, wherein the plurality of repetitions of the first signal and the second signal are transmitted by a base station using beam weights that are progressively increasing in a horizontal domain and a vertical domain, and wherein the first signal is associated with a first antenna port and the second signal is associated with a second antenna port, as described above.

As further shown in FIG. 5, process 500 includes for each repetition of the plurality of repetitions of the first signal and the second signal: extracting, by the test system, first data from the first signal and second data from the second signal, wherein the first data and the second data are associated with one or more wireless communication channels; determining, by the test system and based on the first data and the second data, relative progressive phase differences between the first antenna port and the second antenna port on the horizontal domain and on the vertical domain; and determining, by the test system and based on the relative phase differences, a first beamforming weight associated with the first signal and a second beamforming weight associated with the second signal (block 520). For example, the test system may for each repetition of the plurality of repetitions of the first signal and the second signal: extracting, by the test system, first data from the first signal and second data from the second signal, wherein the first data and the second data are associated with one or more wireless communication channels; determining, by the test system and based on the first data and the second data, relative progressive phase differences between the first antenna port and the second antenna port on the horizontal domain and on the vertical domain; and determining, by the test system and based on the relative phase differences, a first beamforming weight associated with the first signal and a second beamforming weight associated with the second signal, as described above.

As further shown in FIG. 5, process 500 includes estimating a residual error associated with the second antenna port based on the first data, the second data, the first beamforming weight, and the second beamforming weight (block 530). For example, the test system may estimate a residual error associated with the second antenna port based on the first data, the second data, the first beamforming weight, and the second beamforming weight, as described above.

As further shown in FIG. 5, process 500 includes assessing a performance of the base station based on the residual error (block 540). For example, the test system may assess a performance of the base station based on the residual error, as described above.

Process 500 may include additional aspects, such as any single aspect or any combination of aspects described below and/or in connection with one or more other processes described elsewhere herein.

In a first aspect, process 500 includes normalizing, by the test system and based on the first data, the second data to generate normalized second data, wherein the residual error is estimated further based on the normalized second data.

In a second aspect, alone or in combination with the first aspect, the relative progressive phase differences are determined based on an average power difference.

In a third aspect, alone or in combination with one or more of the first and second aspects, determining the relative progressive phase differences comprises utilizing linear regression to determine the relative progressive phase differences.

In a fourth aspect, alone or in combination with one or more of the first through third aspects, determining the relative progressive phase differences comprises removing first noisy data from the first signal, estimating a first phase value associated with the first signal based on removing the first noisy data from the first signal, removing second noisy data from the second signal, estimating a second phase value associated with the second signal based on removing the second noisy data from the second signal, and determining the relative progressive phase differences based on the first phase value and the second phase value.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.” No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a test system, a first signal and a second signal, wherein the first signal and the second signal are transmitted by a base station, wherein the first signal and the second signal are symmetric on a horizontal domain without any beam tilt in a vertical domain, and wherein the first signal is associated with a first antenna port and the second signal is associated with a second antenna port;
extracting, by the test system, first data from the first signal and second data from the second signal, wherein the first data and the second data are associated with one or more wireless communication channels;
normalizing, by the test system and based on the first data, the second data to generate normalized second data;
estimating, by the test system, a residual error associated with the second antenna port based on the normalized second data; and
assessing, by the test system, a performance of the base station based on the residual error.

2. The method of claim 1, wherein estimating the residual error associated with the second antenna port based on the normalized second data comprises:
estimating the residual error associated with the second antenna port based on the normalized second data and based on a first set of beam weights associated with the first signal being a complex conjugate of a second set of beam weights associated with the second signal.

3. The method of claim 1, wherein the residual error associated with the second antenna port comprises one or more of a residual amplitude error or a residual phase error.

4. The method of claim 1, further comprising:
providing information indicating the residual error associated with the second antenna port to the base station.

5. The method of claim 1, wherein extracting the first data and the second data comprises:
extracting one or more first fast Fourier transform (FFT) symbols from the first signal; and
extracting one or more second FFT symbols from the second signal.

6. The method of claim 1, wherein one or more of the first signal or the second signal comprises a synchronization signal block.

7. The method of claim 1, wherein estimating the residual error comprises:
determining a phase difference between the first signal and the second signal based on the normalized second data.

8. The method of claim 1, further comprising:
receiving the first signal and a third signal, wherein the third signal is associated with a third antenna port;
extracting the first data from the first signal and third data from the third signal, wherein the first data and the third data are associated with the one or more wireless communication channels;
normalizing, based on the first data, the third data to generate normalized third data;
estimating a residual error associated with the third antenna port based on the normalized third data; and
assessing the performance of the base station based on the residual error associated with the second antenna port and the residual error associated with the third antenna port.

9. A method, comprising:
receiving, by a test system, a plurality of repetitions of a first signal and a second signal, wherein the plurality of repetitions of the first signal and the second signal are transmitted by a base station using beam weights that are progressively increasing in a horizontal domain and a vertical domain, and wherein the first signal is associated with a first antenna port and the second signal is associated with a second antenna port;
for each repetition of the plurality of repetitions of the first signal and the second signal:
extracting, by the test system, first data from the first signal and second data from the second signal, wherein the first data and the second data are associated with one or more wireless communication channels;
determining, by the test system and based on the first data and the second data, relative progressive phase differences between the first antenna port and the second antenna port on the horizontal domain and on the vertical domain; and
determining, by the test system and based on the relative phase differences, a first beamforming weight associated with the first signal and a second beamforming weight associated with the second signal;
estimating, by the test system, a residual error associated with the second antenna port based on the first data, the second data, the first beamforming weight, and the second beamforming weight; and
assessing, by the test system, a performance of the base station based on the residual error.

10. The method of claim 9, further comprising:
normalizing, by the test system and based on the first data, the second data to generate normalized second data, wherein the residual error is estimated further based on the normalized second data.

11. The method of claim 9, wherein the relative progressive phase differences are determined based on an average power difference.

12. The method of claim 9, wherein determining the relative progressive phase differences comprises:
utilizing linear regression to determine the relative progressive phase differences.

13. The method of claim 9, wherein determining the relative progressive phase differences comprises:
removing first noisy data from the first signal;
estimating a first phase value associated with the first signal based on removing the first noisy data from the first signal;
removing second noisy data from the second signal;
estimating a second phase value associated with the second signal based on removing the second noisy data from the second signal; and
determining the relative progressive phase differences based on the first phase value and the second phase value.

14. A test system, comprising:
one or more memories; and
one or more processors, coupled to the one or more memories, configured to:
receive a first signal and a second signal, wherein the first signal and the second signal are transmitted by a base station, wherein the first signal and the second signal are symmetric on a horizontal domain without any beam tilt in a vertical domain, and wherein the first signal is associated with a first antenna port and the second signal is associated with a second antenna port;
extract first data from the first signal and second data from the second signal, wherein the first data and the second data are associated with one or more wireless communication channels;
normalize, based on the first data, the second data to generate normalized second data;
estimate a residual error associated with the second antenna port based on the normalized second data; and
assess a performance of the base station based on the residual error.

15. The test system of claim 14, wherein the one or more processors, to estimate the residual error associated with the second antenna port based on the normalized second data, are configured to:
estimate the residual error associated with the second antenna port based on the normalized second data and based on a first set of beam weights associated with the first signal being a complex conjugate of a second set of beam weights associated with the second signal.

16. The test system of claim 14, wherein the residual error associated with the second antenna port comprises one or more of a residual amplitude error or a residual phase error.

17. The test system of claim 14, wherein the one or more processors are further configured to:
provide information indicating the residual error associated with the second antenna port to the base station.

18. The test system of claim 14, wherein the one or more processors, to extract the first data and the second data, are configured to:
extract one or more first fast Fourier transform (FFT) symbols from the first signal; and
extract one or more second FFT symbols from the second signal.

19. The test system of claim 14, wherein one or more of the first signal or the second signal comprises a synchronization signal block.

20. The test system of claim 14, wherein the one or more processors, to estimate the residual error, are configured to:
determine a phase difference between the first signal and the second signal based on the normalized second data.
